(19) United States
(12) Patent Application Publication
(10) Pub. No.: US 2008/0260587 A1
(43) Pub. Date: Oct. 23, 2008

(54) Hydrocarbon Preparation System

(76) Inventors: Dennis Coleman, Champaign, IL (US); Kerry Riley, Champaign, IL (US); Dennis Leigh, Staffordshire (GB)

Correspondence Address: Michael L Antoline;One East Main St., One Main Plaza STe.212, Champaign, IL, 61820, US

(21) Appl. No.: 11/631,434

(22) PCT Filed: Jun. 5, 2005
(86) PCT No.: PCT/US2005/024128

§ 371 Date: Jan. 28, 2008

Related U.S. Application Data
(60) Provisional application No. 60/585,239, filed on Jul. 2, 2004.

(51) Int. Cl. G01N 30/00; B32B 5/04

(52) U.S. Cl. 422/89; 210/218

(57) ABSTRACT

An apparatus for the preparation of hydrocarbons for mass spectrographic analysis by their conversion into carbon dioxide. The apparatus uses an isothermic environment for chromatography in conjunction with separate columns tuned to isolate specific hydrocarbons. The apparatus includes a valve block (2), sample extractor (3), sample injector, carrier gas source (10), gas chromatograph (5), combustion furnace (6), water separator (7) open split (8), mass spectormeter (9), reference gas source (10A), and reference gas injector (11).

### PRIOR APPLICATIONS

This application claims the benefit of earlier filed United State Provisional Application 60/585,239 filed Jul. 2, 2004.

### TECHNICAL FIELD

Analysis of gas samples is required in various scientific, environmental and resource contexts. As an example, in oil and natural gas exploration, drilling, recovery and storage, periodic sampling of recovered gases and fluid are required for subsequent isotopic analysis. In the oil industry, “mud” is a colloquial term for a viscous slurry that is pumped into drills as they penetrate the substrate. This “mud” is returned to the surface and contains gases that are released from the rock as the drill penetrates. Significant data is acquired from the analysis of these gases.

New techniques have been developed which now allow the isotopic analysis of very small samples of hydrocarbon gases that are collected from “mud.” Mud gases as they are released are mixtures of hydrocarbon gases and air. In this analytical effort the mixture of hydrocarbon gases is separated by gas chromatography. Gas chromatography will separate out air, carbon dioxide, and the hydrocarbons which will include methane, ethane, propane, butanes, (Iso and N) and pentanes (Iso and N) as examples. After separation, the samples then undergo oxidation by being heated in a combustion furnace in the presence of a metal oxide. The combustion of the hydrocarbons produces carbon dioxide and water.

Hydrocarbons contain two natural stable isotopes, i.e., ¹²C and ¹³C. The carbon dioxide resulting from the combustion of a hydrocarbons will also be composed of these two isotopes. The ratios of these two isotopes, the isotopic composition, will vary with the type of hydrocarbon analyzed and the hydrocarbon's origin. For example, storage gas and native gas may be distinguished by their isotopic compositions. Thermogenic gas and microbial gas may be distinguished as well.

### BACKGROUND ART

Previous apparatus for the preparation of hydrocarbon samples have utilized non isothermic conditions for chromatography. In fact, varying temperatures were used to facilitate the separation of the sample. This caused a significant increase in the amount of time necessary for sample preparation due to heatup/cooldown cycles. Previous systems utilizes pure inert gasses for the carrier gas. To recharge the oxidizing agent in combustion furnaces it becomes necessary to take the furnace offline and run oxygen through the oxidizing agent to recharge it again producing significant delays in analysis. The use of single columns to separate hydrocarbons is problematic in producing the necessary isolation of hydrocarbons in the sample and taking significant periods of time.

### DISCLOSURE OF THE INVENTION

The apparatus presented here uses an electronically controlled injection mechanism, here a syringe and computer controlled servomotor, for injecting a measured quantity of sample gas into an isothermal environment for chromatography in conjunction with separate columns tuned to isolate specific hydrocarbons. This system greatly speeds the analytic process and further allows for more discreet isolation of the hydrocarbons in the sample. Further, a mixture of an inert gas mixed with a small percentage of oxygen allows the continuous recharging of the oxidizing agent within the combustion furnace. The efficient use of carrier gas is also exhibited here by shunting used carrier gas from the open split back into the water separator to carry away water removed from the sample. The coiled use of water separating tubing is seen here which greatly increases the efficiency of water separation with a given space. A stainless steel wire is used as a stylet within the water separating tube to increase the area of gas in contact with the tubing wall also increasing the efficiency of water separation and strengthening the tubing structure. This apparatus also makes use of an on/off valve to eliminate the constant flow of expensive reference gas. The use of the valve is made possible by a reference gas injector that allows only a small amount of reference gas to be pulsed into the mass spectrometer and this is further facility by pressure differentials caused by capillaries joining the reference gas injector and open split. This apparatus can be utilized on almost any currently available brand of isotope ratio mass spectrometer.

### BRIEF DESCRIPTION OF THE DRAWINGS

FIG. 1 is a schematic view of the entire apparatus.

FIG. 2 is a schematic view of the valve block.

FIG. 3 is a schematic view of the gas chromatograph and specifically the methane column in backflush mode.

FIG. 4 is a schematic view of the gas chromatograph and specifically the methane column in combustion mode.

FIG. 5 is a schematic view of the gas chromatograph and specifically the methane column in vent mode.

FIG. 6 is a side view of the combustion furnace.

FIG. 7 is a cross section view of the water separator mechanism.

FIG. 8 is a cross section view of the reference gas injector and open split.

### BEST MODE FOR CARRYING OUT THE INVENTION

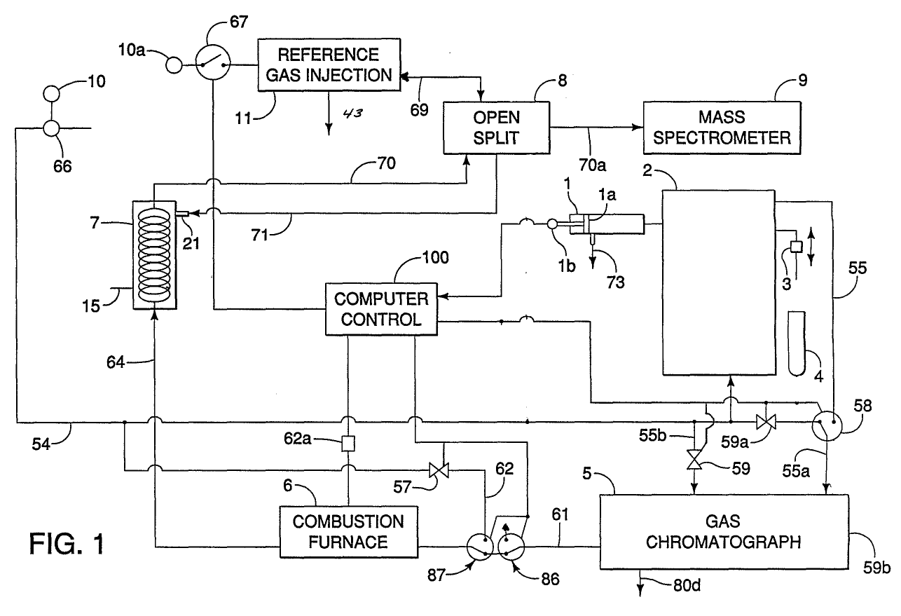

Turning to FIG. 1, the schematic of the Light Hydrocarbon Preparation System is shown. A sample to be analyzed is delivered in a gas sample container 4 such as the Isotube® manufactured by Isotech Laboratories Inc. of Champaign, Ill. A means for extracting the sample to be analyzed from gas sample container 4 is shown as sample extractor 3 which is fluidly connected to gas sample container 4. Valve block 2 is an array of three way valves, 51, 52, and 53. Sample extractor 3 is connected to valve block 2 through port 51c of three way valve 51. Syringe 1, containing plunger 1a with plunger 1a connected to servomotor 1b. The servomotor moves plunger 1a back and forth within syringe 1, thereby loading and unloading sample gas delivered to valve block 2. Depending on the switching within each three-way valve, various functions will be implemented. It should be noted that the term fluidly connected implications the communication between components usually accomplish be means tubing and in most cases stainless steel tubing with the exception of capillary connection. It should also be noted that the term fluidly connected implies a closed and sealable system.

When valve block 2 is in a mode to inject sample into the system for analysis valve 58 is configured to accept sample gas from gas chromatograph input line 55. As the syringe plunger 1 is depressed, the sample is moved into gas chromatograph 5. Once a sample to be analyzed has passed valve 58 the valve is fluidly connected to carrier gas line 54, and the flow of carrier gas will then move the sample through the system. After separation, each component individually moves to the combustion furnace 6 where it is oxidized to carbon dioxide and water. From the combustion furnace 6 the combustion products from each component moves to water separator input line 64, then into water separator 7 where water is removed from the sample leaving dry carbon dioxide. The sample then moves to open split 8 via open split input line 70. For purposes of mass spectrographic analysis, reference gas of known isotopic composition is received from reference gas source 10A. In this case carbon dioxide is the reference gas and may be delivered into the open split 8 immediately after the sample gas pulse. The carrier gas and sample gas or reference gas all enter mass spectrometer 9 via spectrometer input line 70a. Reference gas from reference gas injector 11 enters the open split through reference gas injector output line 69.

The introduction of carrier gas from carrier gas source 10 into the system at other points serves other functions. Combustion furnace carrier gas input line 62 delivers carrier gas into eighth GC valve 87, a three way valve, and into the sample circuit. When seventh GC valve 86, also a three way valve, is configured to vent the gas chromatograph, combustion furnace carrier gas input line 62 provides a continuous source of carrier gas, keeping the remainder of the system pressurized so that the introduction of air and contaminants is eliminated.

Computer control 100 communicates with reference gas valve 67, first three-way valve 51, second three-way valve 52, and third three-way valve 53, gas chromatograph input valve 58, GC valves first through eighth, electronic pressure control valves 1, 2 and 3, chromatograph oven, 59G, and cartridge heater 34 through relay 62a. Computer control 100 is a programmable micro controller manufactured by Advantech. Computer control 100 also causes reference gas valve 67 to open and allow reference gas to enter reference gas injector 11 and thereby create a pulse of reference gas moving into open split 8 and on into mass spectrometer 9 immediately after a sample gas pulse enters mass spectrometer 9. Computer control 100 also regulates the temperature of the combustion furnace by switching on and off cartridge heater 34 based on preprogrammed temperature parameters. Computer control 100 regulates the temperature of chromatograph oven 59G at approximately 80° C. allowing the chromatograph process to continue in isothermal conditions. Computer control 100 also communicates with first three-way valve 51, second three-way valve 52, and third three-way valve 53 in order to place them in purge mode P, syringe loading mode SL, sample injection mode SI and container pressurization mode CP discussed more fully infra.

Computer control 100 maintains the gas chromatograph 5 in fluid communication with carrier gas input line 54 through configuration of chromatograph input valve 58 at all times until valve block 2 is placed in sample injection mode SI. Chromatograph input valve 58 is then configured to shunt the sample gas into gas chromatograph 5. Computer control 100 also configures the array of GC valves, first through eighth in vent mode, backflush mode and combustion mode also discussed infra. When computer control 100 places seventh GC valve 86 in vent mode, or sixth GC valve 85 in backflush mode, it simultaneously configures eighth GC valve 87 to accept carrier gas through combustion furnace carrier gas input line 62 and shunts it into combustion furnace 6. An additional function of computer control 100 is the control of first, second and third electronic pressure control valves respectively 57, 59 and 59a. Second electronic pressure control valve 59 controls the pressure of carrier gas into gas chromatograph 5 through chromatograph flushing line 55b. First electronic pressure control valve 59a controls carrier gas input into gas chromatograph 5 through gas carrier line 54. while third electronic pressure control valve 57 delivers carrier gas to combustion furnace 6. The objective is to maintain constant flow rates through the lines which have electronic pressure control valves attached. For example, the back pressures exerted by the methane, ethane and propane columns vary and when a sample is being introduced into the various columns, the electronic pressure control 58a will increase or decrease pressure to achieve the desired flow rate which has been preprogrammed into computer control 100. Each column must have its backpressures factored into flow rate when backflushing is conducted and this is accomplished by second electronic pressure control 59. Because the backpressure of the combustion furnace changes over time, third electronic pressure control 57 is installed in furnace carrier gas input line 62.

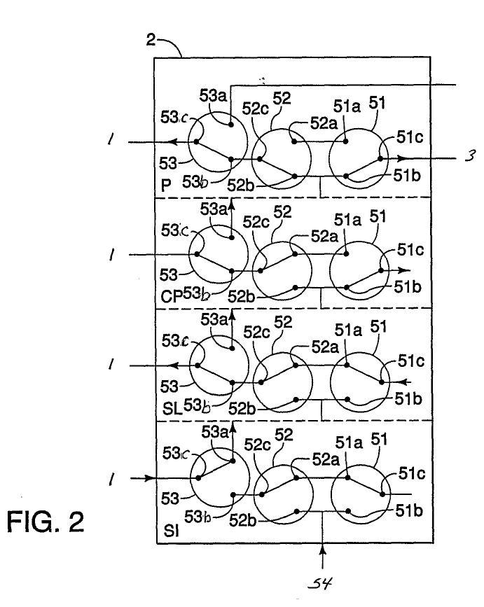

Turning to FIG. 2 it is seen, valve block 2 is composed of a series of three-way valves, first three-way valve 51, second three-way valve 52, and third three-way valve 53. Sample extractor 3 is fluidly connected to first three-way valve 51. Each three-way valve exhibits three inlet/outlet ports specifically, first three-way valve 51 exhibits inlet/outlet ports 51a, 51b, and 51c; second three-way valve 52 exhibits inlet/outlet ports 52a, 52b, and 52c and third three-way valve 53 exhibits inlet/outlet ports 53a, 53b, and 53c. Sample extractor 3, which can be a hypodermic needle is fluidly attached to port 51c of first three-way valve 51. Syringe 1 is fluidly attached to port 53c of third three-way valve 53. Port 53a is fluidly attached to gas chromatograph input valve 58 while ports 52b and 51b are mutually attached to the carrier gas source 10 by carrier gas line 54.

When valve block 2 is in the purge mode P, carrier gas coming from carrier gas source 10 through carrier gas line 54 enters the valve array simultaneously through ports 52b and port 51b. In this configuration port 51b is fluidly connected to 51c which in turn is fluidly connected to sample extractor 3. It can be seen that sample extractor 3 is being flushed with carrier gas. Simultaneously, carrier gas enters port 52b which is fluidly connected with port 52c which is turn is fluidly connected with port 53b which in turn is fluidly connected with port 53c which is fluidly connected to syringe 1. Here, carrier gas flushes syringe 1 and exits purge port 73, as long as syringe plunger 72 is retracted within the syringe to an extent that purge port 73 is open. In this fashion, sample gas remaining in the listed components of the system may be flushed with sample free carrier gas thus clearing the system for a new sample.

In the syringe loading mode SL, it is seen that sample extractor 3 is fluidly connected with port 51c which in turn is fluidly connected with 51a. 51a is, in turn, fluidly connected to 52a. 52a is fluidly connected to 52c and 52c is fluidly connected to 53b which is connected to 53c and then to syringe 1. In this mode, a servomotor will have fully inserted plunger 1a within the syringe body. The servomotor will operate to withdraw syringe plunger 1a creating a vacuum within the syringe which will draw the sample from the gas sampling container 4 through the three-way valve array and into syringe 1. The servomotor will stop retracting the syringe plunger 1a prior to the syringe plunger crossing purge port 73. In this fashion, syringe 1 will be loaded with sample to be analyzed. The servo can be programmed by means of computer control 100 to withdraw the syringe to any point so as to vary the amount of sample loaded.

In the sample injection mode SI, the sample is injected into the gas chromatograph 5. The flow sequence for sample injection mode is as follows: Syringe 1, port 53c, port 53a, GC input line 55, GC input valve 58, gas chromatograph 5. Servomotor 1b then moves plunger 1a fully into syringe 1 thereby compressing the sample and forcing it into gas chromatograph 5.

In the container pressurization mode CP, carrier gas source 10 is fluidly connected again through carrier gas line 54 to both ports 51b and 52b. Port 52b is closed, yet, port 51b is fluidly connected to port 51c. Thus the flow of the carrier gas is directed through sample extractor 3 into sample container 4. This results in the pressurization of the sample container and aids in the subsequent extraction of sample.

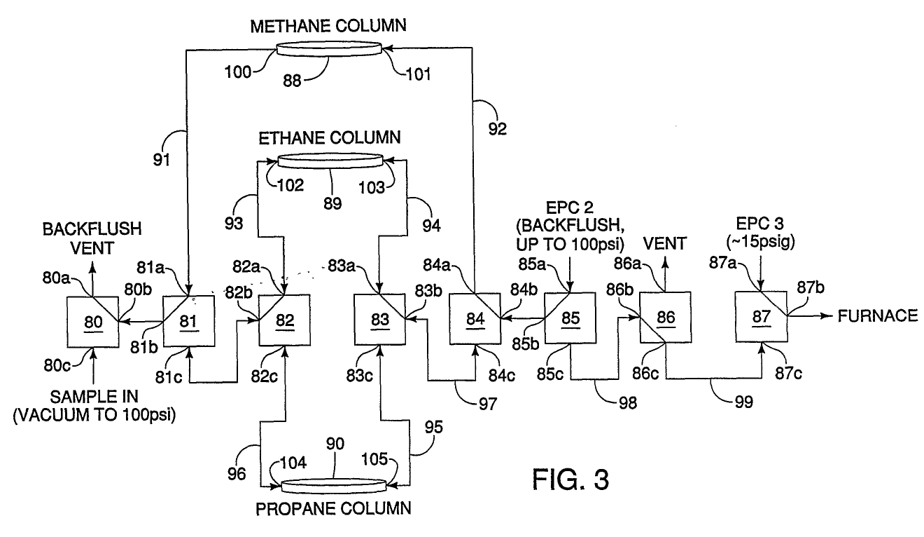

Gas chromatograph 5 is illustrated in various modes in FIGS. 3, 4, and 5 which are discussed infra. The gas chromatograph is composed of an array of gas chromatography columns, methane column 88, ethane column 89, and propane column 90. The gas chromatography columns are designed to produce an isolated sample peak of the named hydrocarbon. Although methane, ethane and propane are of primary interest here, it is likely that other applications would include the analysis of the pentanes and butanes and columns designed to isolate those hydrocarbons could be included. In most conventional applications, a single column is used, however, an innovative aspect of this apparatus is that multiple columns are used to get the particular hydrocarbon peak available as quickly as possible for mass spectrometric analysis. Further, in most conventional configurations and applications the complexity of temperature programmed chromatography is required. The heat up, cool down cycles of these systems greatly lengthens the analysis cycle. By choosing the columns properly, this application allows the chromatographic separation to occur in isothermal conditions which allows the analysis time to be significantly reduced. Also included in the gas chromatograph 5 is an array of three-way valves, first GC (gas chromatography) valve 80, through eighth GC valve 87. Each three-way valve exhibits three ports, for example, first GC valve 80 exhibits port 80a, port 80b, and port 80c.

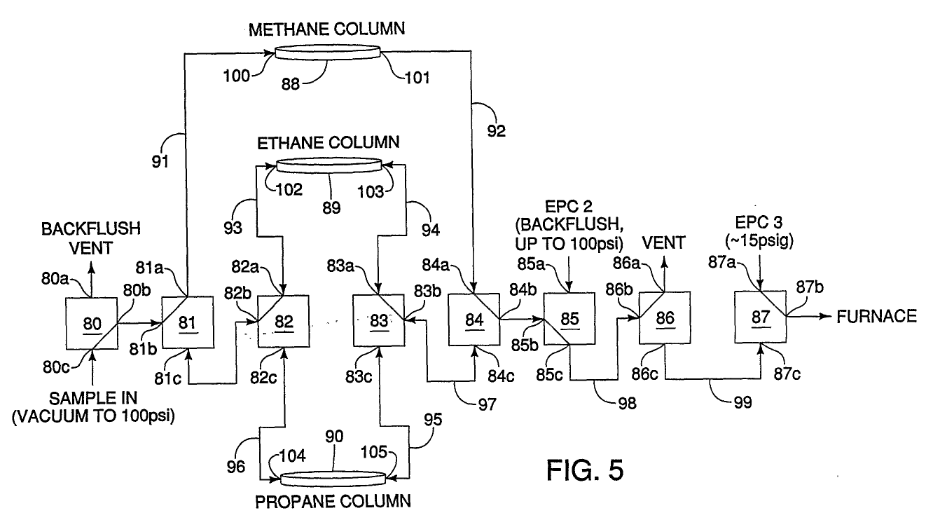

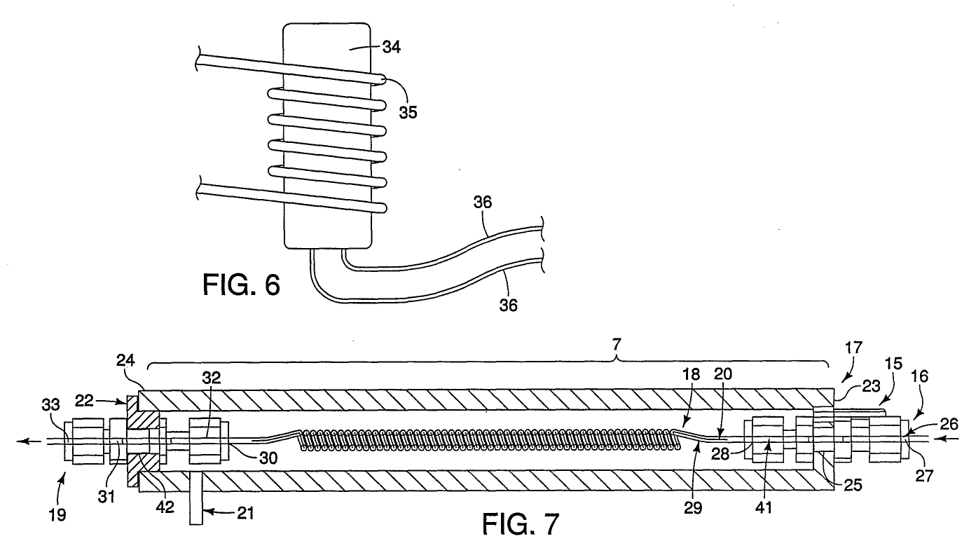

FIG. 5 represents the first mode in sequence which is the venting mode of methane column 88. Here chromatograph input valve 58 is set such that carrier gas is entering gas chromatograph from carrier gas line 54. The carrier gas entering gas chromatograph 5 is controlled by first electronic pressure control 59a seen on FIG. 1, similar to model # VSO manufactured by Parker-Hannafiin. When chromatograph input valve 58 is set to allow sample input from chromatograph input line 55 to enter gas chromatograph 5, the sample is composed of a set of hydrocarbons, air, carbon dioxide and carrier gas which is a helium/oxygen combination. It is undesirable to allow air to enter the combustion furnace and the mass spectrometer. Since air passes through the chromatograph column more quickly than other components of the gas sample, the gas chromatograph output is vented for a period of time to allow the air to be discharged. In the venting mode, the sample enters first GC valve 80 through port 80c which is connected to carrier gas line 54. The flow sequence for the venting mode is as follows: port 80c, port 80b, port 81b, port 81a, methane column inlet line 91, methane column first end 100, methane column 88, methane column second end 101, methane column output line 92, port 84a of fifth GC valve, port 84b, port 85b of sixth GC valve 85, port 85c, port 86b of seventh GC valve 86, port 86a to vent, all ports being fluidly connected. FIG. 5 also exhibits third electronic pressure control 57, also seen in FIG. 1, which controls pressure of the carrier gas through line 62.

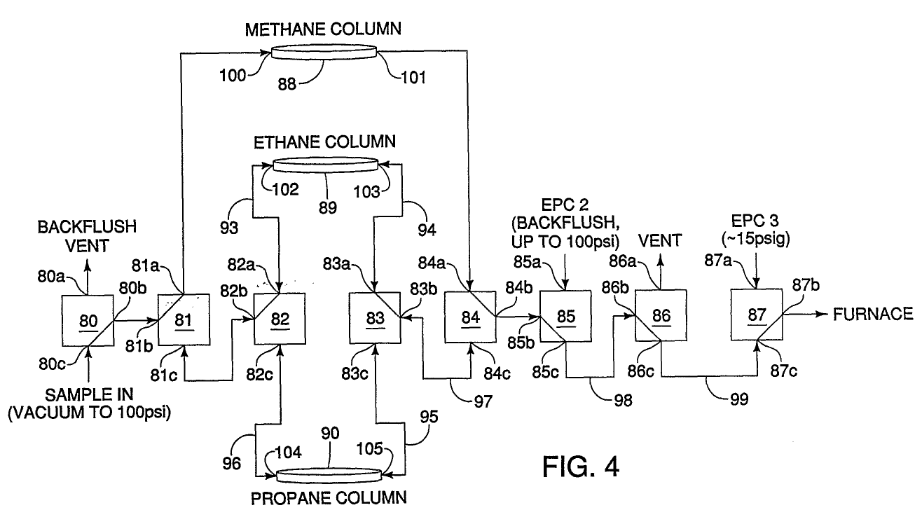

FIG. 4 represents the second mode in sequence which is the combustion mode of methane column 88. The flow sequence for this mode is as follows: port 80c, port 80b, port 81b, port 81a, methane column inlet line 91, methane column first end 100, methane column 88, methane column second end 101, methane column output line 92, port 84a of fifth GC valve 84, port 84b, port 85b of sixth GC valve 85, port 85c, port 86b of seventh GC valve 86, port 86c, port 87c of Eighth GC valve 87, port 87b and into combustion furnace input line 61 and into combustion furnace 6.

FIG. 3 represents the third mode in sequence which is the backflush mode of methane column 88. Here carrier gas from carrier gas line 54 through line 55b and second electronic control 59 enters the system through port 85a of sixth GC valve 85. The backflush sequence is as follows: port 85b, port 84b of fifth GC valve 84, port 84a to methane column output line 92, methane column second end 101, methane column 88, methane column first end 100, methane column inlet line 91, valve 81a of second GC valve 81, port 81b to port 80b of first GC valve 80, port 80a to backflush vent 80d. Backflushing removes the remainder of the sample allowing the introduction of a new sample to be tested.

When gas chromatograph 5 is in backflush mode or vent mode, the carrier gas stream is vented. This cuts off the carrier gas stream through the combustion furnace, water separator and most critically the open split. It is necessary for the open split to remain pressurized with carrier gas to prevent the introduction of air into open split 8 and then into mass spectrometer 9. To prevent this, when seventh GC valve 86 is in vent configuration, or sixth GC valve 85 is in backflush configuration, eighth GC valve 87 will simultaneously be configured so that carrier gas from line 62 is introduced into port 87a and on through the system to open split 8 maintaining carrier gas pressure within.

The path thorough the ethane column for all modes is as follows: port 81c, port 82b, port 82a, ethane column inlet line 93, ethane column first end 102, ethane column 89, ethane column second end 103, ethane column output line 94, port 83a of fourth GC valve 83, port 83b, port 84c of fifth GC valve.

The path through the propane column for all modes is as follows: port 81c, port 82b, port 82c, propane column input line 96, propane column first end 104, propane column 90, propane column second end 105, propane column output line 95, port 83c, port 83b and port 84c.

The venting modes for the ethane and propane columns are identical to that of the methane column from ports 80c through 81b and from ports 84b through 85a to vent. However, the ethane column is vented when ports 81b, 81c and 82b, 82a are fluidly connected and ports 83a, 83b and 84c, 84b are fluidly connected. The propane column is vented when ports 81b, 81c and 82b, 82c are fluidly connected and ports 84c, 84b and 83b, 83c are fluidly connected.

The combustion modes for the ethane, and propane columns are identical to that of the methane column from ports 80c through 81b and from ports 84b through combustion furnace. However, the ethane column is in combustion mode when ports 81b, 81c and 82b, 82a are fluidly connected and ports 83a, 83b and 84c, 84b are fluidly connected. The propane column is in combustion mode when ports 81b, 81c and 82b, 82c are fluidly connected and ports 84c, 84b and 83b, 83c are fluidly connected.

The backflush modes for the ethane, and propane columns are identical to that of the methane column from ports 80b through 81b and from ports 84b through 85a. The backflush mode for the ethane column is implemented when 83a, 83b and 84c, 84b are fluidly connected and 81b, 81c and 82b, 82a are fluidly connected. The backflush mode of the propane column would require ports 84c, 84b and 83b, 83c to be fluidly connected and ports 81b, 81c and 82b, 82c to be fluidly connected. For purposes of backflushing, carrier gas is drawn from the carrier gas source 10 by means of chromatograph flushing line 55b fluidly connected to the electronic pressure control 59.

The carrier gas utilized here is composed of approximately 99% helium and 1% oxygen. In traditional configurations, the oxidation material utilized in the combustion furnace must be taken off line and recharged with oxygen. With the use of the helium/oxygen carrier, the oxidation agent used in this system is continuously recharged eliminating the down time in traditional systems due to recharging.

Combustion Furnace 6 is composed of a standard cartridge heater 34, similar to Model # Hi-Temp manufactured by Fastheat. Cartridge heaters are used because they are inexpensive and easily replaceable. Cartridge heater 34 is connected to an electrical source through conductors 36. Combustion furnace tube 35, composed of metal tubing in this instance is coiled around the cartridge heater 34. It exhibits first combustion tube end 35a and second combustion tube end 35b. First combustion tube end 35c is fluidly connected to port 87b of eighth GC valve 87. Second combustion tube end 35c is fluidly connected to line 64. Combustion furnace tube 35 is packed with an oxidizing agent such as cupric oxide is used. Here the hydrocarbon pulses generated by the gas chromatograph are individually converted into carbon dioxide and water.

Water separator 7 is shown in FIG. 7 and consists of a sealable container 17 through which water separating tube 18 is disposed. Water separating tube 18 is composed of a substance that will transmit water through its walls, but not other gases. The tubing is similar to Nafion® that produced by Perma Pure LLC. In this application water separating tubing 18 is coiled within sealable container 17 with approximately 1 meter of the tubing being enclosed. Longer or shorter lengths may be used. Sealable container 17 exhibits first container end 23 and second container end 24. First container end 23 exhibits bore 25 through which first connector 16 is disposed producing a seal. Connectors are capable of accepting and sealing around tubing inserted in the connector ends thereby creating a fluid retaining seal. First connector 16 exhibits a first connector longitudinal bore 41 with a first longitudinal bore first end 27 and a first longitudinal bore second end 28. Water separating tube 18 exhibits tubing first end 29 and tubing second end 30. Tubing first end 29 connects with first longitudinal bore first end 28, similarly, second connector 19 exhibits second connector longitudinal bore 31. Second connector longitudinal bore 31 exhibits a second longitudinal bore first end 33 and a second longitudinal bore second end 32 which fluidly connects to tubing second end 30 by means of connector 19. Second container end 24 is sealed with sealing cap 22 which is removable. Sealing cap 22 exhibits sealing cap bore 42 through which second connector 19 is sealably disposed. Second longitudinal bore first end 33 is fluidly connected to said open split 8 through line 70. First longitudinal bore first end 27 is fluidly connected to said combustion furnace 6 through line 64. Sealable container 17 also exhibits inlet 21 which receives flushing carrier gas from said open split 8. Outlet 15 of sealable container 17 vents the flushing carrier gas to the atmosphere whereby water is removed from water separator 7.

In this application, water separating tubing 18 has an inside diameter of approximately 0.7 millimeters. A corresponding length of stainless steel wire forming a stylet 20 of an outside diameter of approximately 0.5 millimeters is inserted through water separating tubing 18. Stylet 20 serves three functions. The first function is that the stainless steel wire allows tubing 18 to be formed into its coil shape, thereby increasing the length of water separating tubing 18 incorporated within water separator 7. The second function is that the presence of the stylet 20 which occupies a significant portion of the inside diameter of tubing 18 and forces the gas sample into close contact with the wall of water separating tube 18, consequently promoting the effectiveness of water removal from the sample gas stream flowing through water separating tubing 18. Finally, the stylet strengthens and stabilized the water separator tubing and making the structure much more durable.

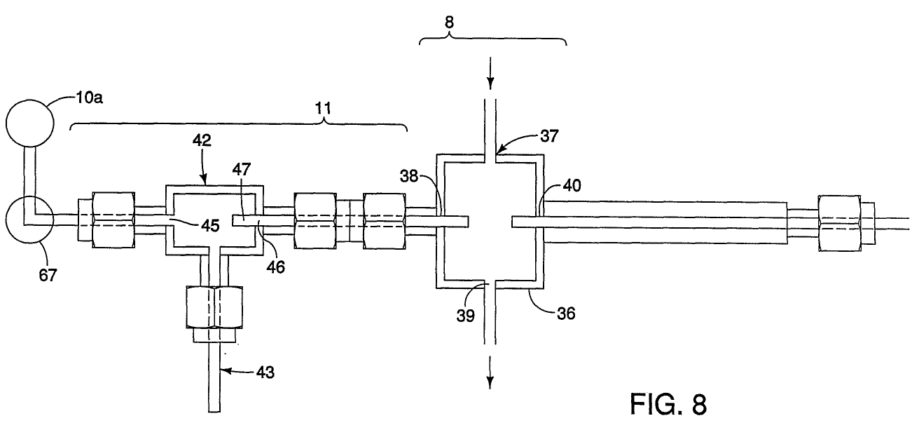

FIG. 8 exhibits the apparatus termed the open split 8 and is comprised of open split chamber 36. The open split is a small chamber that can be simply stainless steel tubing. Open split chamber 36 exhibits sample gas inlet 37, reference gas inlet 38, return outlet 39, and sample gas outlet 40. Sample gas inlet 37 is fluidly connected with water separator 7 through second connector 19 by way of line 70. The sample gas from water separator 7 is dumped into the open split chamber 36. The sample gas outlet is a very small opening and is fluidly connected to the inlet of the mass spectrometer 9. The sample gas outlet 40 is of such a small inside diameter that negative pressure generated within mass spectrometer 9 has little effect on the pressure within open split chamber 36, but allows a small amount of sample gas from the open split to consistently bleed into mass spectrometer 9. The amount of sample gas bleeding into the mass spectrometer 9 is a small fraction of the total gas passing through the open split. The larger volume of gas entering the open split through sample gas inlet 37 exits open split chamber 36 through return outlet 39 which is fluidly connected to inlet 21 of sealable container 17. The dry gas then circulates around water separating tube 18 and flushes the water extracted from the sample gas within the water separating tube out outlet 15 which is then vented. This serves to flush the sealable container thereby removing water from the water separator. The recycling use of the carrier gas significantly reduces the amount of carrier gas used in this application. The return outlet 39 is restricted in diameter such that the pressure within the open chamber 39 is maintained slightly above the ambient pressure.

The sample gas pulse is analyzed by the mass spectrometer as it enters that instrument. For accurate isotopic analysis it is also necessary to introduce a pulse of carbon dioxide of precisely known isotopic composition into the mass spectrometer, at a time very close to the time when the sample gas is analyzed. This pulse of gas of known composition is referred to as the reference gas and in the case of the current instrument, that reference gas is carbon dioxide. The mechanism for introducing that reference gas is identified as the reference gas injector 11, seen also in FIG. 8. The standard procedure within the industry for introducing reference gas continuously into the open split is to simply have a piece of tubing which constantly flows expensive CO₂ reference gas into the open split area. The system shown here allows one to have reference gas valve 67 between the CO₂ reference gas source 10A and the reference gas injector 11 such that it can be closed off except during the time period when it is desirable to introduce reference gas into the open split. The reason it is not possible to do this by simply opening and closing a line going into the open split is the extremely small quantity of gas that is desired. Virtually any valve on the market would have such a high dead volume that it would result in large surges of CO₂ introduced into the open split whenever the valve was turned on, which would be detrimental to accurate isotopic analysis.

Turning to FIG. 8 once again, we see the reference gas injector 11. This is composed of a reference gas source 10A which is usually a high pressure cylinder. Between reference gas source 10A and reference gas injector 11 is reference gas valve 67 which provides a simple on and off function. Reference gas valve 67 is fluidly connected to the reference gas injector chamber 42 through injector chamber inlet 45. With the system shown there is an additional piece of small capillary tubing 47 that connects the reference gas injector chamber 42 to open split 8 by way of injector chamber outlet 46. The reference gas injector chamber is again a piece of tubing, or a tee that is vented through injector chamber vent 43 which is a restricted vent. Because the open split 8 is at slightly above ambient pressure, when valve 44 is closed, there is a very slight flow of helium (or whatever carrier gas is in the open split 8) backwards from the open split 8 to the reference gas injector chamber 42, which, of course implies there is no flow from the reference gas injector 11 into the open split 8. When valve 67 on the reference gas source 10A is opened, it results in a pressure in the reference gas injector chamber 42 that is slightly higher than the pressure in open split 8. Although most of the reference gas is actually is vented from reference gas injector chamber 42, a small, controlled amount of reference gas flows into the open split allowing for the pulse of reference gas needed for the analysis. The controlled flow of reference gas into the open split is accomplished by use of a capillary tube 47. The length and diameter of the capillary tube may be varied of between 50 and 100 microns in diameter and between 1 and 10 centimeters. By varying the diameter and lengths, flow rates may be controlled. The capillary tube 47 fluidly connects reference gas injector 11 and open split 8. Most of the reference gas actually exits injector chamber vent 43, but because valve 44 need be open only for a very short time period, the amount of expensive reference gas utilized is much less that with conventional systems.

What is claimed is:

1. A hydrocarbon preparation system whereby a sample of hydrocarbons is withdrawn from a sample container and is converted into carbon dioxide for isotopic analysis said hydrocarbon preparation system comprising:
a. a valve block whereby said sample is accepted into said hydrocarbon preparation system,
b. a sample extractor fluidly connected to said valve block, whereby said sample is drawn into said valve block,
c. a sample injector comprising an electronically controlled variable volume container, fluidly connected to said valve block and said sample extractor whereby sample is deposited for injection into said hydrocarbon preparation system,
d. a carrier gas source, fluidly connected to said valve block, whereby said sample may be carried through said hydrocarbon preparation system, whereby said hydrocarbon preparation system may be flushed and whereby said hydrocarbon system may remain pressurized,
e. a gas chromatograph fluidly connected to said valve block whereby said hydrocarbons in said sample are separated,
f. a combustion furnace fluidly connected to said gas chromatograph whereby said hydrocarbons in said sample are oxidized and converted into carbon dioxide and water,
g. a water separator fluidly connected to said combustion furnace whereby said water in said converted sample is removed from said sample,
h. an open split fluidly connected to said water separator, whereby sample size is reduced and whereby the opportunity for isotope fractionation is diminished,
i. a mass spectrometer fluidly connected to said open split whereby said sample is analyzed,
j. a reference gas source fluidly connected to said hydrocarbon preparations system whereby said mass spectrometer may be calibrated,
k. a reference gas injector fluidly connected to said reference gas source said reference gas injector also fluidly connected to said open split whereby said reference gas may be periodically introduced in to said mass spectrometer.

2. The valve block of claim 1 further comprising:
a. A valve array consisting of a plurality of three way valves fluidly connected to said sample injector, said gas chromatograph, said carrier gas source and said sample extractor, said array capable of being configured such that said sample injector and sample extractor may be flushed with said carrier gas, whereby said array is capable of being configured such that a sample may be drawn through said valve block into said sample extractor, from said sample container and introduced into said sample injector, said array is capable of being configured such that said sample container may be pressurized, whereby said sample may be extracted from said sample container, said array capable of being configured such that said sample injector may inject said sample into said gas chromatograph.

3. The valve block of claim 2 further comprising:
a. a gas chromatograph input valve fluidly connected to said carrier gas source and fluidly connected with and between said valve block and said gas chromatograph whereby said gas chromatograph may receive a constant flow of carrier gas until said valve array is configured such that sample injector will inject said sample into said gas chromatograph.

4. The gas chromatograph of claim 1 further comprising:
a. a plurality of separating columns whereby said sample is separated into discrete hydrocarbons thereby quickly isolating said hydrocarbons,
b. an array of three way valves fluidly connected to said separating columns said array capable of being configured such that said sample may be shunted into any individual member of said plurality,
c. a chromatograph heater whereby said chromatograph is maintained in isothermic conditions.

5. The hydrocarbons of claim 1 drawn from a class composed of methane, ethane, propane, isobutane, n-butane, isopentane, n-pentane and hydrocarbons containing greater than five carbon atoms,

6. The array of three way valves of claim 4 further comprising:
a. a first GC valve having a backflush vent said first GC valve fluidly connected to said valve block and said carrier gas source, said first GC valve having a first electronic pressure control between said first GC valve and said carrier gas source, a second GC valve fluidly connected to said first GC valve, a third GC valve fluidly connected to said second GC valve, a fourth GC valve, a fifth GC valve fluidly connected to said fourth GC valve, a sixth GC valve fluidly connected to said carrier gas source said sixth GC valve having a second electronic pressure control between said sixth GC valve and said carrier gas source, said sixth GC valve fluidly connected to said fifth GC valve, a seventh GC valve having a primary vent, said seventh GC valve fluidly connected to said sixth GC valve, an eighth GC valve fluidly connected to said combustion furnace, said carrier gas source, said eighth GC valve having a third electronic pressure control between said eighth GC valve and said carrier gas source, said eighth electronic pressure control fluidly connected to said seventh GC valve.

7. The plurality of separating columns of claim 4 further comprising: a first column, a second column and a third column, said first column chromatographically configured to separate methane, said second chromatographically configured to separate ethane, said third column chromatographically configured to separate propane, said first column fluidly connected to said second GC valve and said fifth GC valve, said second column fluidly connected said third GC valve and said fourth GC valve, said third column fluidly connected to said third GC valve and said fourth GC valve.

8. The valve array of claim 6 capable of being configured such that carrier gas may backflush said methane, ethane and propane columns independently, further capable of being configured to introduce sample into said methane, ethane and propane columns independently, further capable of being configured to independently vent said separated hydrocarbon samples to allow air and other contaminates to vent from said chromatograph prior to introduction into said combustion furnace, further capable of introducing said sample into said combustion furnace.

9. The open split of claim 1 further comprising: an open split chamber having a reference gas inlet, a sample gas inlet, a sample gas outlet, said reference gas inlet fluidly connected to said reference gas injector, said sample gas inlet fluidly connected to said water separator and said sample gas outlet fluidly connected to said mass spectrometer.

10. The sample gas outlet of claim 9 whereby a small volume of sample gas may be passed into said mass spectrometer and whereby the negative pressure generated within said mass spectrometer has little effect on the pressure within said open split chamber.

11. The open split chamber of claim 9 further comprising a return outlet, said return outlet fluidly connected to said water separator whereby excess carrier gas may be utilized to remove water from said sealable container.

12. The return outlet of claim 11 further comprising a restriction whereby the positive pressure of the said incoming sample gas will maintain the pressure within the open split above ambient pressure.

13. The reference gas injector of claim 1 comprising:
a. a reference gas source,
b. a reference gas valve fluidly connected to said reference gas source,
c. a reference gas injector chamber fluidly connected to said valve,
d. a injector chamber outlet, said outlet having a restricted diameter, fluidly connected to said reference gas injector chamber, said injector chamber fluidly connected to said open split.
e. a restricted injector chamber vent whereby reference gas is vented.

14. The injector chamber outlet of claim 13 further comprising a capillary tube.

15. The capillary tube of claim 14 of a diameter of between 50 microns and 100 microns.

16. The reference gas injector of claim 13 whereby when said valve when open produces a pressure in said reference gas injector chamber such that said reference gas flows into said open split producing stream of reference gas for spectrometric analysis.

17. The reference gas injector of claim 13 whereby when said valve, when closed, in conjunction with said injector chamber vent allows pressure within said reference gas injector chamber to reduce to a pressure less than that in said open split allowing backflow and termination of the stream of reference gas flowing into said open split.

18. A water separator comprising:
a. a sealable container,
b. a water separating tube having a first tube end and a second tube end said water separating tube disposed within said container whereby water is removed from said carrier gas said carrier gas being within said water separating tube, said water being deposited within said chamber.

19. The sealable container of claim 18 further comprising an inlet and an outlet whereby said water deposited within said chamber may be removed.

20. The sealable container of claim 19 further comprising:
a. a first container end and a second container end said first container end having a bore, said second container end having a sealing cap said sealing cap having a cap bore,
b. a first connector sealably disposed within said first container end bore, said first connector having a first connector first end and a first connector second end, said first connector end fluidly connected to said first tube end, said second connector end fluidly connected to said combustion chamber outlet line,
c. a second connector sealably disposed within said cap bore of said sealing cap, said second connector having a second connector first end and a second connector second end, said second connector second end fluidly connected to said second tube end, said first connector end fluidly connected to said open split inlet line.

21. The sealable container of claim 20 further comprising:
a. said inlet fluidly connected to said open split whereby excess carrier gas is used to remove water from said water separator,
b. said outlet vented to the atmosphere.

22. The water separating tube of claim 18 further comprising a stylet composed of a formable material inserted within said water separating tubing whereby said water separating tubing may be shaped into a coil structure, whereby the length of the tubing within sealable container may be increased and whereby said water separating tube may be strengthened and stabilized.

23. The water separating tube of claim 22 further comprising a stylet composed of a material of such a diameter to allow gas to flow through said water separating tube and whereby said a unit of said carrier gas is exposed to a greater surface area of said water separating tubing.

24. The stylet of claim 23 wherein said stylet is composed of metal wire.

25. The combustion furnace of claim 1 whereby sample gas is converted into carbon dioxide and water comprising:
a. a heat source,
b. a container in proximity to said heat source said container accepting said sample,
c. an oxidizing agent contained within said container.

26. The heat source of claim 25 wherein said heat source comprises a cartridge heater.

27. The container of claim 25 wherein said container comprises metal tubing said metal tube coiled around said heat source, said metal tube having a steel tube first end and a metal tube second end, said metal tube first end fluidly connected to said gas chromatograph said metal tube second end fluidly connected to said water separator.

28. The oxidizing agent of claim 25 comprising an oxidizing agent comprised of cupric oxide.

29. The carrier gas of claim 1 comprising an inert gas and oxygen whereby said oxidizing agent may be recharged.

30. The hydrocarbon preparation system of claim 1 further comprising a computer control said computer control communicating with said reference gas valve, said first three-way valve, said second three-way valve, said third three-way valve, said syringe servo motor, said gas chromatograph input valve, said GC valves first through eighth, said first, second and third electronic pressure control valves, and said cartridge heater, whereby said computer control 100 causes said reference gas valve to open and allow reference gas to enter said reference gas injector and thereby create a pulse of reference gas moving into said open split and on into said mass spectrometer immediately after said sample enters mass spectrometer, further whereby computer control 100 regulates temperature of said combustion furnace by switching on and off said cartridge heater based on preprogrammed temperature parameters and further whereby computer control 100 also communicates with said first three-way valve, said second three-way valve 52, and said third three-way valve whereby said array capable of being configured such that said sample injector and sample extractor maybe flushed with said carrier gas, whereby said array is capable of being configured such that a sample may be drawn into said valve block from said sample container and introduced into said sample injector, said array is capable of being configured such that said sample container may be pressurized, whereby said sample may be extracted from said sample container, said array capable of being configured such that said sample injector may inject said sample into said gas chromatograph, further whereby said computer control 100 maintains the gas chromatograph 5 in fluid communication with carrier gas through configuration of chromatograph input valve at all times until said valve block is configured to inject said sample into said gas chromatograph, further whereby said computer control configures chromatograph input valve to shunt the sample gas into gas chromatograph 5, further whereby computer control 100 configures the array of GC valves, first through eighth in to vent, backflush said columns and send sample to said combustion furnace, further whereby said computer control seventh GC valve 86 to vent sample, it simultaneously configures eighth GC valve to accept carrier gas and shunt it into combustion furnace further whereby computer control communicates with first, second, and third electronic pressure control valves said second electronic pressure control valve 59 controlling pressure of carrier gas into said gas chromatograph said first electronic pressure control valve controlling carrier gas input into gas, said third electronic pressure control valve delivers carrier gas to said combustion furnace, whereby constant flow rates are maintained in spite of varying backpressures exerted, further whereby said computer control communicates with said syringe servo motor, so that varying amounts of sample may be drawn into sample extractor.
